(19) United States
(12) Patent Application Publication
(10) Pub. No.: US 2009/0259609 A1
(43) Pub. Date: Oct. 15, 2009

(54) METHOD AND SYSTEM FOR PROVIDING A LINEAR SIGNAL FROM A MAGNETORESISTIVE POSITION SENSOR

(75) Inventor: Anthony Dmytriw, DeKalb, IL (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc.

(21) Appl. No.: 12/103,348

(22) Filed: Apr. 15, 2008

(51) Int. Cl. G06N 3/02

(52) U.S. Cl. 706/22

(57) ABSTRACT

A method and system for providing a linear signal from a non-contact magnetoresistive position sensors utilizing a multilayer perception neural network. The neural network multiplies a number of non-linear inputs from the magnetoresistive position sensor by a number of first layer interconnection weights, which are summed by a number of first layer summing nodes and processed by a number of nonlinear activation function. The processed data can then be multiplied by a number of second layer interconnection weights and summed by an output layer-summing node. The output from the output layer-summing node can further be processed by an output activation function in order to produce a linear output signal.

### TECHNICAL FIELD

Embodiments are generally related to magnetoresistive sensors. Embodiments are also related to techniques and devices for providing linear signals from magnetoresistive sensors. Embodiments are additionally related to position sensors. Embodiments are also related to neural networks.

### BACKGROUND OF THE INVENTION

Position sensors can be utilized to electronically monitor the position or movement of a mechanical component. Position sensors produce data that may be expressed as an electrical signal that varies as the position of the mechanical component changes. Such position sensors are typically utilized in machines to sense or control the mechanical position of one entity with respect to another in an automated system. In most cases, it is advantageous for the sensor entity not to make contact with the entity being sensed in order to eliminate the effects of mechanical wear over time.

A magnetoresistive array position sensor, meaning the complete sensor is composed of multiple magnetoresistive position sensor elements, can be implemented as a non-contact type of sensor, which is a device that generates a change to an electronically interrogated physical parameter proportional to the movement of a structure, such as, for example, an actuator shaft operatively coupled to the sensor. Such a change can be achieved without physical contact between the parameter and the interrogation device. A problem associated with such magnetoresistive position array sensors is that the output of each magnetoresistive sensor element is non-linear in nature with respect to the position of the entity being sensed.

Prior art techniques for providing a linear output generally involve the use of a predetermined sequential mathematical transfer function defined within a microcontroller. Such an approach produces a linear output by utilizing a ratio calculation of adjacent sensor element signals then applying multiple sinusoidal correction factors approximated during calibration to correct for the non-linearity produced in the ratio calibration.

In order to describe the multiple sinusoidal correct factors accurately, without aliasing, many data points must be taken from each sensor element with respect to position.

Such a predetermined sequential mathematical transfer function renders the system incompatible to changes during the execution. Additionally, such techniques are restricted to position sensors and cannot provide a generalized solution that can be used to serve many sensor applications providing non-linear signals.

Based on the foregoing it is believed that a need exists for an improved method and system for providing a linear output signal from multiple non-contact magnetoresistive sensors as described in greater detail herein.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved magnetoresistive position sensor method and system.

It is another aspect of the present invention to provide for an improved method and system for producing a linear output signal from a magnetoresistive position sensor.

It is another aspect of the present invention to provide for an improved method and system for linearizing a signal from multiple non-linear output signals obtained from individual sensor elements for many sensor applications.

It is a further aspect of the present invention to provide for an improved multi layer perception (MLP) neural network for linearizing a non-linear output signal.

The aforementioned aspects and other objectives and advantages can now be achieved as described herein. A method and system for providing a linear signal from a non-contact magnetoresistive (MR) position sensor utilizing a multilayer perception (MLP) neural network is disclosed herein. The MLP neural network multiplies a plurality of non-linear inputs from the MR position sensors by a number of first layer interconnection weights, which are then summed by a number of first layer summing nodes and processed utilizing one or more nonlinear activation functions. The processed data can be then multiplied by a number of second layer interconnection weights and summed by an output layer-summing node. The output from the output layer-summing node can further be processed by an output activation function in order to produce a linear output signal.

The MLP neural network defines the interconnection weights or multipliers of different neuron connections to establish a transfer function. Such a transfer function can be utilized to produce an output, which is linear with respect to the position of the entity being sensed. The MLP neural network can be a non-linear function approximating tool wherein the parameters of the networks are determined by applying optimization methods. The optimization of the parameters can be accomplished with respect to an approximation error measure. Such a method of producing the linear output signal can be accomplished with fewer calibration points than prior art requires.

A back-propagation algorithm can also be utilized to “learn” the approximation of the non-linear function. Such an approach for providing a linear signal from a magnetoresistive position sensor can be applied to linearize signals from airflow and pressure sensors over temperature. Similarly, it is also possible to develop a single linearizing MLP neural network and utilize the same technology with many sensor applications.

### BRIEF DESCRIPTION OF THE DRAWINGS

The accompanying figures, in which like reference numerals refer to identical or functionally similar elements throughout the separate views and which are incorporated in and form a part of the specification, further illustrate the embodiments and, together with the detailed description, serve to explain the embodiments disclosed herein.

FIG. 1 illustrates a schematic diagram of a process for linearizing non-linear magnetoresistive signals from one or more magnetoresistive position sensors, in accordance with a preferred embodiment;

FIG. 2 illustrates a schematic diagram of the architecture of an MLP neural network for linearizing non-linear magnetoresistive signals from one or more magnetoresistive position sensors, in accordance with a preferred embodiment;

FIG. 3 illustrates a graphical representation of two non-linear magnetoresistive signals, in accordance with a preferred embodiment;

FIG. 4 illustrates a graphical representation of a desired linear signal output and a linear signal output generated by an MLP neural network, in accordance with a preferred embodiment; and

FIG. 5 illustrates a detailed flow chart of operations illustrating logical operational steps of a method for linearizing non-linear magnetoresistive signals from one or more magnetoresistive position sensors utilizing an MLP neural network, in accordance with a preferred embodiment.

### DETAILED DESCRIPTION

The particular values and configurations discussed in these non-limiting examples can be varied and are cited merely to illustrate at least one embodiment and are not intended to limit the scope thereof.

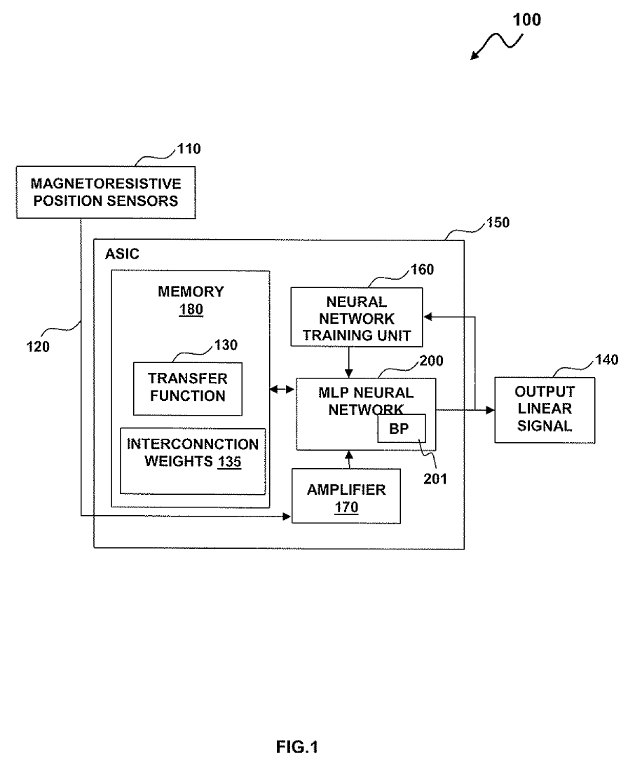

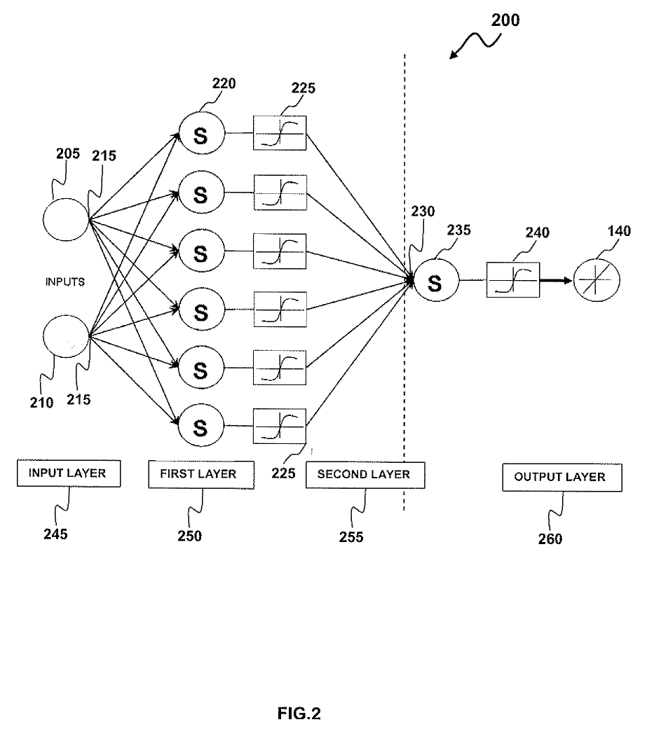

Referring to the drawings and in particular to FIG. 1, there is depicted a schematic diagram of a system 100 for linearizing a number of non-linear MR signals 120 from a group of magnetoresistive position sensors 110, in accordance with a preferred embodiment. System 100 generally includes two or more magnetoresistive sensors 110 in association with an ASIC (Application Specific Integrated Circuit) 150. The ASIC 150 can include the use of a memory 180 containing interconnection weights 135 and a transfer function 130. The ASIC 150 further includes an amplifier, a neural network 200, and an MLP (multilayer percpetron) neural network training unit 160. One signal can be output from the neural network 200 in the form of a linear signal 140. The MLP neural network 200 can further incorporate the use of a back-propagation (BP) module 201, which is discussed in greater detail herein with respect to FIG. 2.

Note that module 201 may constitute a physical component and/or a software module. In the context of programming, a software module can be thought of as a collection of routines and data structures that perform particular tasks or implement particular abstract data types. If a software module, such a module usually includes two parts: an interface, which lists the constants, data types, variables, and routines that are accessible by other modules or routines, and an implementation, which is provide and accessible only to that particular module. Module 201 can thus contain source code that implements the routines within module 201, depending upon design considerations. Module 201 may also constitute a hardware component and may be implemented as a self-contained component that can provide a complete function of back-propagation to the MLP neural network 200 and may be interchanged with other hardware modules to provide similar functions if necessary.

The magnetoresistive position sensors 110 can be electrically connected to the ASIC 150. Note that the ASIC 150 functions as an integrated circuit (IC) customized for accommodating the MLP neural network 200. The ASIC 150 generally includes an amplifier 170, which provides an electrical signal to the MLP neural network 200. ASIC 201 further includes a memory 180 that can be utilized to store interconnection weights 135 and a transfer function 130 utilized by the MLP neural network 200. Memory 180 and amplifier 170 are electrically connected to the MLP neural network 200.

The non-linear output signals 120 from the magnetoresistive position sensors 110 can be provided to the amplifier 170 and are subject to amplification by the amplifier 170. The data stored in memory 180 and an amplified non-linear signal from the amplifier 170 can be provided as input signals to the MLP neural network 200. Thus, the embodiments described herein can be implemented utilizing ASIC 201 mated with magnetoresistive position sensors 110. The MLP neural network 200 can utilize the transfer function 130, which is required in obtaining a linear signal 140.

The MLP neural network 200 can function utilizing a back-propagation (BP) module 201. BP module 201 implements a BP algorithm. Note that module 201 can be provided in the context of a software module. The neural network 200 can be trained utilizing a neural network-training unit 160. The neural network-training unit 160 adjusts the interconnection weights 135 between the neurons by employing BP algorithm, which is a gradient-based optimization algorithm. The output data related to the linear signal 140 is repeatedly presented to the MLP neural network 200. The MLP neural network output 140 can be compared to a desired output 410 and an error function computed by the neural network-training unit 160. The error function defines the total difference between the actual output 140 and the desired output 410 of the network 200 over a set of training patterns. The error is then fed back (i.e., back-propagated) to the MLP neural network 200 and can be utilized to adjust the interconnection weights 135 such that the error decreases with respect to each iteration in order to produce the desired output 410.

FIG. 2 illustrates a schematic diagram of the architecture of the MLP neural network 200 for linearizing non-linear magnetoresistive signals from magnetoresistive position sensors 110, in accordance with a preferred embodiment. Note that in FIGS. 1-4, identical or similar parts or elements are generally indicated by identical reference numerals. In general, a neural network is a powerful data-modeling tool that can capture and represent complex input/output relationships. Neural networks possess the ability to represent both linear and non-linear relationships directly from the data being modeled. The most common neural network model is the MLP neural network, such as, for example, MLP neural network 200. In the context of the disclosed embodiments, MLP neural network 200 creates a model that correctly maps the input to the output utilizing historical data so that the model can then be utilized to produce an output when the desired output 410 is unknown.

The MLP neural network 200 discussed herein involves four layers: an input layer 245, a first layer 250, a second layer 255 and an output layer 260. The first layer 250 and the second layer 255 can be each termed a “hidden layer”. The non-linear magnetorestive signals 205 and 210 from the magnetoresistive position sensors 110 can be fed to the input layer 245 which is multiplied by a number of first layer interconnection weights 215 associated with the first layer 250. Thereafter, the multiplied output are summed by a number of first layer summing nodes 220 and then processed by a number of first layer activation functions 225, within the first layer 250.

The processed data from the first layer 250 can then be passed to a second layer 255 and is multiplied by a number of second layer interconnection weights 230. The multiplied output are summed by an output layer-summing node 235 associated with an output layer 260 and then processed by an output activation function 240 in order to produce a linear signal 140. Note that the embodiments discussed herein generally include two non-linear input signals 205 and 210 from magnetoresistive sensors 110 in order to produce a linear output signal 140. It will be apparent to those skilled in the art, however, that any number of non-linear input signals can be utilized in order to produce a linear output signal 140 as desired without departing from the scope of the invention described herein.

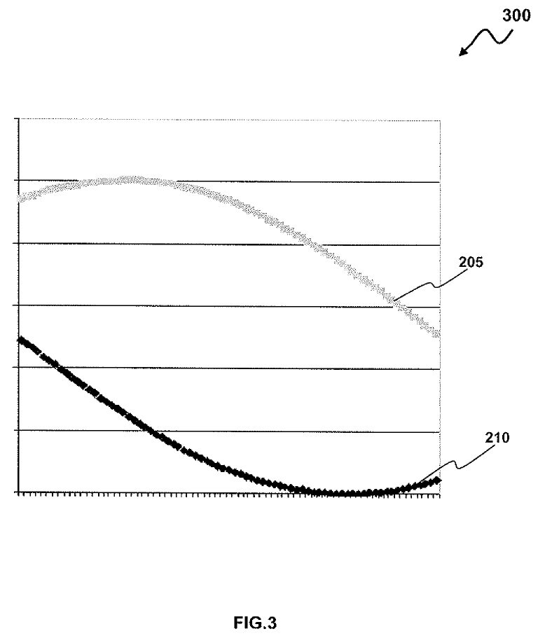

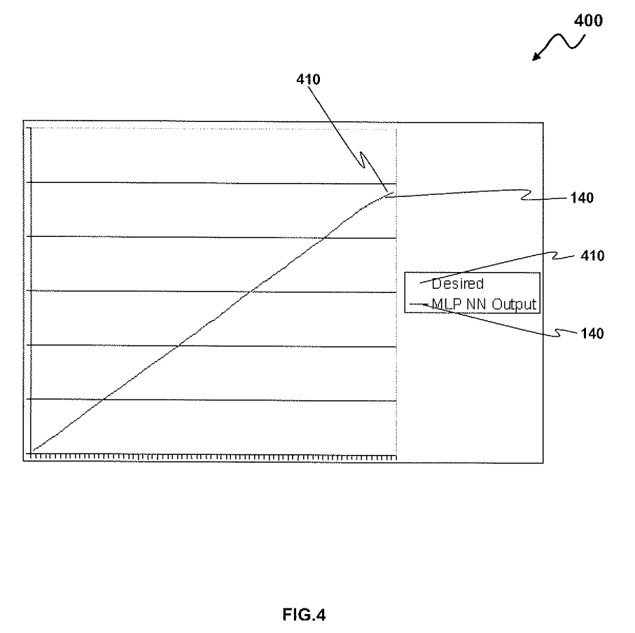

FIG. 3 illustrates a graph 300 depicting data representative of two non-linear magnetoresistive signals 205, 210, in accordance with a preferred embodiment. As indicated in graph 300, the magnetoresistive sensor output signal 205 and the magnetoresistive sensor output signal 210 can be converted into a single linear signal 140 (see FIG. 4) utilizing the multi-layer perception (MLP) neural network 200 described earlier.

FIG. 4 illustrates a graph 400 of a desired linear signal output and the linear signal output generated by the MLP neural network 200, in accordance with a preferred embodiment, FIG. 4 depicts a small deviation in the MLP neural network output 140 when compared to the desired output 410. However, such small deviation indicates an error of 3% in the MLP neural network output 140. The error of 3% can also be reduced by further optimization of parameters by the neural network-training unit 160 in order to produce the desired output 410.

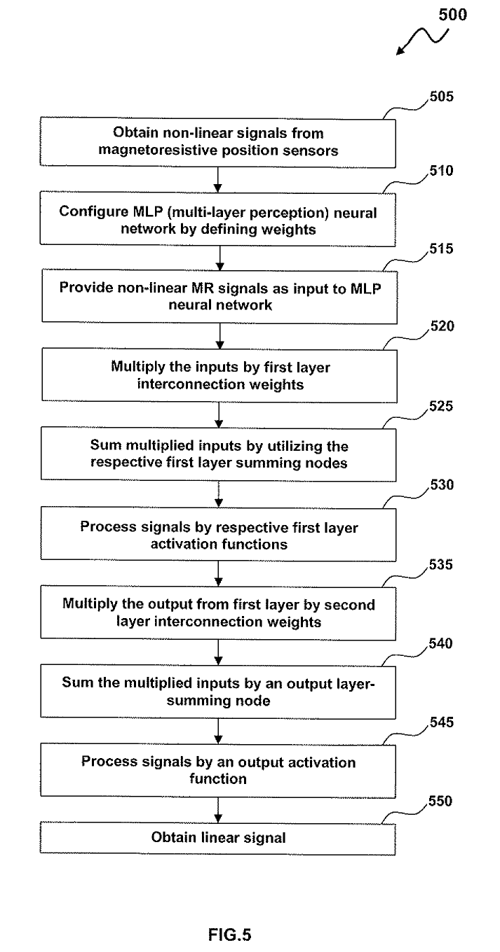

FIG. 5 illustrates a detailed flow chart of operations illustrating logical operational steps of a method 500 for linearizing non-linear magnetoresistive signals from one or more magnetoresistive position sensors utilizing MLP neural network 200, in accordance with a preferred embodiment. Non-linear magnetoresistive signals 120 from magnetoresistive position sensors 110 can be obtained, as depicted at block 505. The MLP neural network 200 can be configured by defining weights, as illustrated at block 510. Thereafter, as indicated at block 515, the non-linear magnetoresistive signals 120 can be provided as inputs to the MLP neural network 200. The non-linear magnetoresistive signals 120 can be multiplied by a number of first layer interconnection weights 215, as shown at block 520. The multiplied signals can then be summed by utilizing a first layer summing nodes 220, as depicted at block 525.

Next, as described at block 530, the signals can be processed by a number of first layer activation functions 225 within the first layer 250. The output from the first layer 250 can be multiplied by a number of second layer interconnection weights 230, as depicted at block 535. The multiplied signals can be summed by an output layer summing node 235 associated with the second layer 225, as illustrated at block 540. Thereafter, as depicted at block 545, the signals can be processed by an output activation function 240. A linear signal 140 can be obtained as output, as depicted at block 545.

It is believed that by utilizing the method 500 described herein, the non-linear magnetoresistive sensor signals can be converted into a linear signal 140 by utilizing the MLP neural network 200. Further, the magnetoresistive position sensor 110 eliminates the effects of mechanical wear over time by making zero contact with the entity being sensed. The method can be adapted for producing the linear signal 140 with fewer calibration points than previous art. Similarly, it is also possible to develop a single linearizing MLP neural network and utilize the same technology for many sensor applications.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for providing a linear signal from a magnetoresistive position sensor utilizing a neural network, comprising:
receiving at least two non-linear input signals from at least two magnetoresistive position sensors;
processing said at least two non-linear input signals by a plurality of first layer interconnection weights, a plurality of summing nodes and a plurality of nonlinear activation functions associated with a first layer of said neural network; and
processing said at least two non-linear input signals from said first layer by a plurality of second layer interconnection weights, an output layer summing node and an output activation function associated with a second layer of said neural network in order to form a linear signal associated with an output layer thereto.

2. The method of claim 1 further comprising providing said neural network as an MLP neural network.

3. The method of claim 1 further comprising;
establishing a transfer function utilizing said neural network, wherein said neutral network is defined by said plurality of first layer interconnection weights, said plurality of second layer interconnection weights, and said output activation function associated with different neuron connections thereof.

4. The method of claim 1 further comprising modifying said neural network to produce said linear signal, wherein said linear signal is linear with respect to an entity being sensed.

5. The method of claim 1 further comprising configuring said neural network to include a sufficient number of calibration points to produce said linear output.

6. The method of claim 1 further comprising configuring said neural network as in a semiconductor chip utilizing CMOS technology and/or bipolar technology.

7. The method of claim 1 further comprising configuring said neural network to utilize a back-propagation module for approximating said linear output signal.

8. A method for providing a linear signal from a magnetoresistive position sensor utilizing a neural network, comprising:
providing said neural network as an MLP neural network;
receiving at least two non-linear input signals from at least two magnetoresistive position sensors;
processing said at least two non-linear input signals by a plurality of first layer interconnection weights, a plurality of summing nodes and a plurality of nonlinear activation functions associated with a first layer of said neural network; and
processing said at least two non-linear input signals from said first layer by a plurality of second layer interconnection weights, an output layer summing node and an output activation function associated with a second layer of said neural network in order to form a linear signal associated with an output layer thereto, wherein said neural network produces said linear signal, which is linear with respect to an entity being sensed.

9. The method of claim 8 further comprising;
establishing a transfer function utilizing said neural network wherein said neutral network is defined by said plurality of first layer interconnection weights, said plurality of second layer interconnections weights and said output activation function associated with different neuron connections thereof.

10. The method of claim 8 further comprising configuring said neural network to include a sufficient number of calibration points to produce said linear output.

11. The method of claim 8 further comprising providing said neural network in a semiconductor chip utilizing CMOS technology.

12. The method of claim 8 further comprising providing said neural network in a semiconductor chip utilizing bipolar technology.

13. The method of claim 8 further comprising configuring said neural network to utilize a back-propagation module for approximating said linear output signal.

14. A system for providing a linear signal from a magnetoresistive position sensor utilizing a neural network, comprising:
at least two magnetoresistive position sensors, wherein at least two non-linear input signals are received from said at least two magnetoresistive position sensors;
a plurality of first layer interconnection weights, a plurality of summing nodes and a plurality of nonlinear activation functions associated with a first layer of said neural network, wherein said at least two non-linear input signals are processed by said plurality of first layer interconnection weights, said plurality of summing nodes and said plurality of nonlinear activation functions; and
a plurality of second layer interconnection weights, an output layer summing node and an output activation function associated with a second layer of said neural network, wherein said at least two non-linear input signals are processed from said first layer by said plurality of second layer interconnection weights, said output layer summing node and said output activation function, in order to form a linear signal associated with an output layer thereto.

15. The system of claim 14 wherein said neural network comprises an MLP neural network.

16. The system of claim 14 further comprising;
a transfer function established utilizing said neural network, wherein said neutral network is defined by said plurality of first layer interconnection weights, said plurality of second layer interconnection weights, and said output activation function associated with different neuron connections thereof.

17. The system of claim 14 wherein said neural network produces said linear signal, wherein said linear signal is linear with respect to an entity being sensed.

18. The system of claim 14 wherein said neural network includes a sufficient number of calibration points to produce said linear output.

19. The system of claim 14 wherein said neural network is configured in a semiconductor chip utilizing CMOS technology and/or bipolar technology.

20. The system of claim 14 wherein said neural network utilizes a back-propagation module for approximating said linear output signal.
